(19) United States
(12) Patent Application Publication
(10) Pub. No.: US 2025/0200325 A1
(43) Pub. Date: Jun. 19, 2025

(54) METHOD AND DEVICE FOR GRAPH EXTERNAL ATTENTION (GEA)-GUIDED MULTI-VIEW GRAPH REPRESENTATION LEARNING

(71) Applicant: Shanxi University, Taiyuan City (CN)

(72) Inventors: Jianqing LIANG, Taiyuan City (CN); Min CHEN, Taiyuan City (CN)

(21) Appl. No.: 18/975,371

(22) Filed: Dec. 10, 2024

(30) Foreign Application Priority Data
Dec. 19, 2023 (CN) 202311750481.3

(51) Int. Cl. G06N 3/042; G06N 3/045; G06N 3/0499; G06N 3/082

(52) U.S. Cl. CPC G06N 3/042; G06N 3/045; G06N 3/0499; G06N 3/082

(57) ABSTRACT

A method and device for graph external attention (GEA)-guided multi-view graph representation learning are provided. The method includes: acquiring a node feature, an edge feature, and an adjacent matrix of an input graph; calculating, by a feature encoding module, a node embedding and an edge embedding of the graph; learning, by a global self-attention module, internal global view information of the graph, and outputting a first node representation; learning, by a message passing module, internal local view information of the graph, and outputting a second node representation and a first edge representation; learning, by a graph external attention module, external view information of the graph, and outputting a third node representation and a second edge representation; and performing, by a normalization module, batch normalization and random dropout on output information, and combining using a multilayer perceptron combination module to obtain a target output of a model.

### CROSS REFERENCE TO RELATED APPLICATION

This patent application claims the benefit and priority of Chinese Patent Application No. 202311750481.3, filed with the China National Intellectual Property Administration on Dec. 19, 2023, the disclosure of which is incorporated by reference herein in its entirety as part of the present application.

### TECHNICAL FIELD

The present disclosure relates to the technical field of neutral networks, and in particular, to a method and device for graph external attention (GEA)-guided multi-view graph representation learning.

### BACKGROUND

Numerous huge data networks in the real world can be represented by graphs, such as a social media relationship, a molecular interaction, a transportation network, and a web page link. Graph representation learning is intended to effectively map graph data to a low-dimensional vector space. Due to data being from multiple sources, the graph data will present different represents in different views. Multi-view graph representation learning utilizes information from a plurality of views such that learned representations are more comprehensive and accurate. Existing multi-view graph representation learning studies have achieved a certain progress, but most of them only take internal information of graphs into account. In many graphs (e.g., protein molecule graphs) in the real world, different graphs (molecules) tend to have strong correlations therebetween. The correlations between different graphs are taken into account such that graph information is learned more sufficient, helping improve the quality of graph representations.

Therefore, the present disclosure provides a method for GEA-guided multi-view graph representation learning. A plurality of external feature memory units are utilized to learn external view information of a graph and integrate the learned view information with internal information of the graph such that more sufficient and expressive graph representations are learned.

### SUMMARY

An objective of the present disclosure is to provide a method and device for GEA-guided multi-view graph representation learning to solve the problem of model inaccuracy caused by neglecting external view information of a graph in the prior art.

To achieve the above objective, the present disclosure provides the following technical solutions.

The present disclosure provides a method for GEA-guided multi-view graph representation learning, the method applied to a system for GEA-guided multi-view graph representation learning, the system including: a feature encoding module, a global self-attention module, a message passing module, a graph external attention module, a normalization module, and a multilayer perceptron combination module; the method including:
acquiring a node feature, an edge feature, and an adjacent matrix of an input graph;
calculating, by the feature encoding module, based on the node feature, the edge feature, and the adjacent matrix, a node embedding and an edge embedding of the graph;
learning, by the global self-attention module, according to the node embedding, internal global view information of the graph, and outputting a first node representation of the global self-attention module;
learning, by the message passing module, according to the node embedding and the edge embedding, internal local view information of the graph, and outputting a second node representation and a first edge representation of the message passing module;
learning, by the graph external attention module, according to the node embedding and the edge embedding, external view information of the graph, and outputting a third node representation and a second edge representation of the graph external attention module; and
performing, by the normalization module, batch normalization and random dropout on the first node representation, the second node representation, the first edge representation, the third node representation, and the second edge representation, and combining using the multilayer perceptron combination module to obtain a target output of a model.

The present disclosure provides a device for GEA-guided multi-view graph representation

learning, the device applied to a system for GEA-guided multi-view graph representation learning, the system including: a feature encoding module, a global self-attention module, a message passing module, a graph external attention module, a normalization module, and a multilayer perceptron combination module; the device including:
at least one processor and a memory in communication connection with the at least one processor, where the memory stores instructions executable by the at least one processor, and the instructions, when executed by the at least one processor, enable the at least one processor to:
acquire a node feature, an edge feature, and an adjacent matrix of an input graph;
calculate, by the feature encoding module, based on the node feature, the edge feature, and the adjacent matrix, a node embedding and an edge embedding of the graph;
learn, by the global self-attention module, according to the node embedding, internal global view information of the graph, and output a first node representation of the global self-attention module;
learn, by the message passing module, according to the node embedding and the edge embedding, internal local view information of the graph, and output a second node representation and a first edge representation of the message passing module;
learn, by the graph external attention module, according to the node embedding and the edge embedding, external view information of the graph, and output a third node representation and a second edge representation of the graph external attention module; and
perform, by the normalization module, batch normalization and random dropout on the first node representation, the second node representation, the first edge representation, the third node representation, and the second edge representation, and combine using the multilayer perceptron combination module to obtain a target output of a model.

The present disclosure provides a computer storage medium, storing instructions which, when run, cause the method described above to be implemented.

A method for GEA-guided multi-view graph representation learning provided in the present disclosure is applied to a system for GEA-guided multi-view graph representation learning, the system including: a feature encoding module, a global self-attention module, a message passing module, a graph external attention module, a normalization module, and a multilayer perceptron combination module. The method includes: acquiring a node feature, an edge feature, and an adjacent matrix of an input graph; calculating, by the feature encoding module, based on the node feature, the edge feature, and the adjacent matrix, a node embedding and an edge embedding of the graph; learning, by the global self-attention module, according to the node embedding, internal global view information of the graph, and outputting a first node representation of the global self-attention module; learning, by the message passing module, according to the node embedding and the edge embedding, internal local view information of the graph, and outputting a second node representation and a first edge representation of the message passing module; learning, by the graph external attention module, according to the node embedding and the edge embedding, external view information of the graph, and outputting a third node representation and a second edge representation of the graph external attention module; and performing, by the normalization module, batch normalization and random dropout on the first node representation, the second node representation, the first edge representation, the third node representation, and the second edge representation, and combining using the multilayer perceptron combination module to obtain a target output of a model. With the method provided in the present disclosure, the model may be enabled to learn more accurate node representations and thus to more effectively process downstream tasks. In addition, a convergence rate of model training may be increased using a batch normalization method such that the model training process is more stable and the gradient exploding or gradient vanishing problem is avoided. The external view information of a graph is fully explored, and a message passing network and a global self-attention mechanism are combined to learn the internal view information of the graph.

### BRIEF DESCRIPTION OF THE DRAWINGS

The accompanying drawings described herein are provided for further understanding of the present disclosure, and constitute a part of the present disclosure. The exemplary embodiments and illustrations of the present disclosure are intended to explain the present disclosure, but do not constitute inappropriate limitations to the present disclosure. In the accompanying drawings:

FIG. 1 is a model framework diagram of a system for GEA-guided multi-view graph representation learning;

FIG. 2 is a flowchart of a method for GEA-guided multi-view graph representation learning;

FIG. 3 is a schematic diagram of a graph external attention module; and

FIG. 4 is a schematic diagram of a device for GEA-guided multi-view graph representation learning.

### DETAILED DESCRIPTION OF THE EMBODIMENTS

For the ease of clearly describing the technical solutions in the embodiments of the present disclosure, words “first”, “second” and the like are used in the embodiments of the present disclosure to distinguishing same or similar items that are basically the same in function and effect. For example, the first threshold and the second threshold are merely for the purpose of distinguishing different thresholds, rather than limiting a sequential order. Those skilled in the art should understand that the terms such as “first” and “second” are not intended to limit the number and execution sequence and are not necessarily intended to be different.

It is to be noted that the words “exemplary” or “for example” or the like represents serving as an example, instance or illustration in the present disclosure. Any embodiment or design solution described herein as “exemplary” or “for example” should not be construed as being more preferred or advantageous over other embodiments or design solutions. Exactly, use of “for example”, “example”, or the like is intended to present a related concept in a specific manner.

In the present disclosure, the term “at least one” refers to one or more types, and the term “multiple” refers to two or more types. The term “and/or” is an association relationship for describing associated objects, and represents that three relationships may exist, for example, A and/or B may represent that: A exists alone, A and B exist at the same time, and B exists alone. The character “/” usually indicates an “or” relationship between associated objects. The term “at least one of the following items” or similar expression refers to any combination of these items, including any combination of single items or plural items. For example, at least one of a, b or c may be expressed as: a, b, c, a+b, a+c, b+c or a+b+c; and the a, b and c may be the single items, and may also be the plural items.

In existing multi-view graph representation learning, correlations between a plurality of graphs (e.g., protein molecule graphs) are not taken into account. Different graphs (molecules) tend to have strong correlations therebetween. Therefore, the problem of external view information of a graph is neglected in existing studies.

Solutions provided by embodiments of the present disclosure are described below with reference to the drawings.

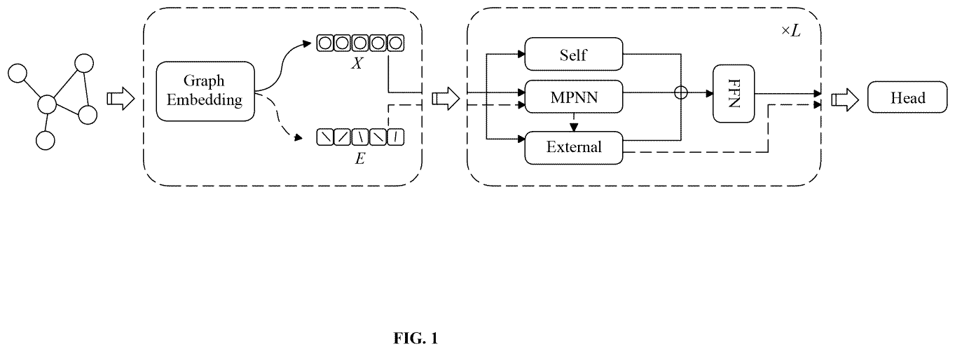

The solutions provided in the present disclosure are applied to a system for GEA-guided multi-view graph representation learning. A model framework of the system is as shown in FIG. 1, and the system includes a feature encoding module, a global self-attention module, a message passing module, a graph external attention module, a normalization module, and a multilayer perceptron combination module. It needs to be noted that FIG. 1 does not show all structures. FIG. 1 is merely used to represent the model framework provided in the present disclosure. As shown in FIG. 1, after Graph Embedding, a node embedding X and an edge embedding E are obtained, and input to the global self-attention module (Self), the message passing module (MPNN), the graph external attention module (External), and based on a feedforward neural network (FNN), a network output content is finally acquired through a Head network.

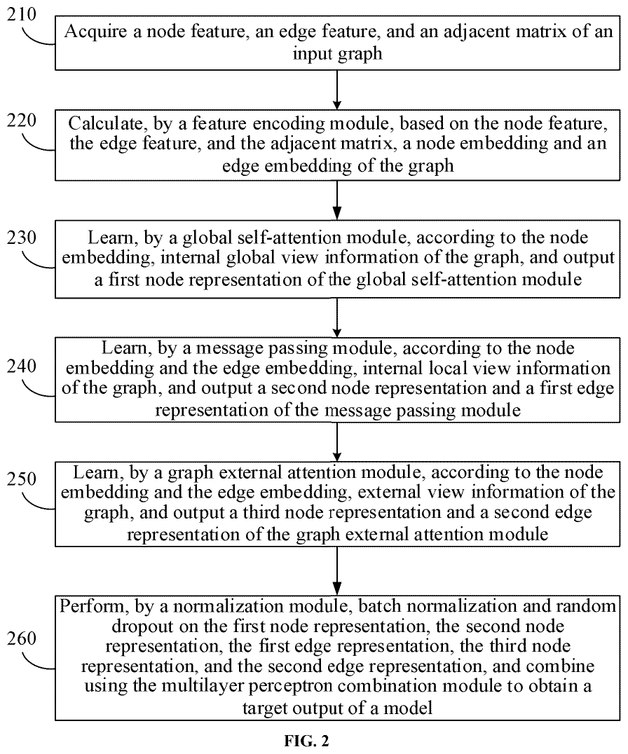

Based on the model framework in FIG. 1, a specific application process of the method provided in the present disclosure is as shown in FIG. 2, which may include the following steps.

In step 210, a node feature, an edge feature, and an adjacent matrix of an input graph are acquired.

More specifically, step 210 may be implemented based on the following steps.

A position code P of a node is pre-calculated according to the adjacent matrix. In the present disclosure, Laplacian positional encoding or random walk positional encoding is used (which is selected according to characteristics of a dataset).

The position code P is concatenated with an initial node feature X⁰, and a dimension of a feature is controlled using a linear encoder to obtain the node embedding X:

$$X = NodeLinearEncoder [ Concat ( {X}^{0} , P ) ] \qquad ( 1 )$$

where NodeLinearEncoder represents a node feature encoder, and Concat represents a concatenating operation.

Similarly, the initial edge feature E⁰ needs to be input to the linear encoder to control a dimension of the edge feature to obtain an edge embedding matrix E:

$$E = EdgeLinearEncoder ( {E}^{0} ) \qquad ( 2 )$$

where EdgeLinearEncoder represents an edge feature encoder.

In step 220, the feature encoding module calculates a node embedding and an edge embedding of the graph based on the node feature, the edge feature, and the adjacent matrix.

More specifically, step 220 includes the following steps.

The node embedding X is input to the global self-attention module, and matrices of a query Q, a key K, and a value V are obtained by linear projection, where Q=XW_{Q}, K=XW^{K}, and V=XW_{V}.

The matrices of Q, the key K, and the value V are substituted into formulas (3) and (4):

$${X}^{″} = {X}^{′} + SelfAttn ( {X}^{′} ) \qquad ( 5 )$$

$${X}^{′′′} = FFN ( ( {X}^{″} ) := ReLU ( {X}^{″} {W}_{1} ) {W}_{2} \qquad ( 6 )$$

for calculating a self-attention;
where A represents an attention matrix; n represents a number of nodes; dₒᵤₜ refers to a feature dimension of Q; W_{Q}, W_{K}, and W_{V} are learnable parameter matrices; and Norm represents normalization, which utilizes a softmax function;

A plurality of self-attentions are calculated and concatenated to obtain a multi-head self-attention; and an output X′ of the multi-head self-attention is passed through a residual connection and a feedforward neural network to obtain a final output X′″ of the global self-attention module, as shown in formulas (5) and (6):

$${X}^{′} = SelfAttn ( X ) := AV ∈ {ℝ}^{n \times {d}_{out}} \qquad ( 3 )$$

$$A = Norm ( \frac{{QK}^{T}}{\sqrt{{d}_{out}}} ) \qquad ( 4 )$$

where FFN represents the feedforward neural network, and ReLU represents an activation function.

In step 230, the global self-attention module learns internal global view information of the graph according to the node embedding and outputs a first node representation of the global self-attention module.

More specifically, step 230 includes the following steps.

A node v is given, where a process of message passing for updating a feature is as follows:

$${m}_{v}^{( t + 1 )} = {\sum }_{u ∈ N ( v )} \frac{1}{\vert N ( v ) \vert} {h}_{u}^{( t )} \qquad ( 7 )$$

$${h}_{v}^{( t + 1 )} = Combine ( {h}_{v}^{( t )} , {m}_{v}^{( t + 1 )} ) \qquad ( 8 )$$

where t represents a number of combination steps; hᵥ⁽⁰⁾ represents an initial embedding of the node v;

$${m}_{v}^{( t + 1 )}$$

represents a message passing process, which is a combination message of the node v at step t+1; N(v) represents a neighbor node set of the node v;

$${h}_{v}^{( t + 1 )}$$

represents a node representation of the node v after updating; and Combine represents a combination function.

In step 240, the message passing module learns internal local view information of the graph according to the node embedding and the edge embedding and outputs a second node representation and a first edge representation of the message passing module. The step includes the following steps.

A node embedding matrix X∈ [symbol] ^{n×d} is input, where n represents a number of nodes; and d represents a feature dimension of a node.

A shared feature memory unit M₀∈ [symbol] ^{d×d} of a node and an edge is used to calculate a product of the node and the shared feature memory unit, and a node representation is updated:

$${X}^{′} = X {M}_{0} \qquad ( 9 )$$

A first external node feature memory unit Mₙ₁∈ [symbol] ^{S×d} is used to calculate and a similarity matrix A_{node} of the first external node feature memory unit and the node:

$${A}_{node} = ( {X}^{′} {M}_{n 1}^{T} ) \qquad ( 10 )$$

where Norm represents a normalization function, and S represents a size of a memory unit.

A second external node feature memory unit Mₙ₂∈ [symbol] ^{S×d} is used to update a feature from the external node feature memory unit with a similarity in A_{node}:

$${X}^{″} = {A}_{node} {M}_{n 2} ∈ {ℝ}^{n \times d} \qquad ( 11 )$$

where X″ represents a node representation output by the graph external attention module.

An edge embedding matrix E∈ [symbol] ^{e×d} d is input, where e represents a number of edges; and d represents a feature dimension of an edge. The shared feature memory unit M₀∈ [symbol] ^{d×d} is used to calculate a product of the edge and the shared feature memory unit, and an edge representation is updated:

$${E}^{′} = {E M}_{0} \qquad ( 12 )$$

A first external edge feature memory unit Mₑ₁∈ [symbol] ^{S×d} is used to calculate and a similarity matrix of the first external edge feature memory unit and the edge:

$${A}_{edge} = Norm ( {E}^{′} {M}_{e 1}^{T} ) \qquad ( 13 )$$

A second external edge feature memory unit Mₑ₂∈ [symbol] ^{S×d} is used to update an input feature of the external edge feature memory unit with a similarity in A_{edge}:

$${E}^{″} = {A}_{edge} {M}_{e 2} ∈ {ℝ}^{e \times d} \qquad ( 14 )$$

where E″ represents edge representation output by the graph external attention module.

In step 250, the graph external attention module learns external view information of the graph according to the node embedding and the edge embedding and outputs a third node representation and a second edge representation of the graph external attention module.

The first node representation, the second node representation, and the third node representation are denoted as \hat{X}_{T}^{l}, \hat{X}_{M}^{l}, and \hat{X}_{E}¹, respectively, where 0<l<L; l represents a current number of layers; L represents a total number of layers; T, M, and E represent the global self-attention module, the message passing module, and the graph external attention module, respectively; and three outputs are separately passed through a Dropout function to prevent model overfitting.

Normalization processing is performed using a batch normalization method BatchNorm Thus, a convergence rate of model training is increased such that the model training process is more stable and the gradient exploding or gradient vanishing problem is avoided.

Further, the global self-attention module, the graph external attention module, and the message passing module are represented with formulas, respectively:

$${X}_{T}^{l} = BatchNorm ( Dropout ( {\hat{X}}_{T}^{l} ) + {X}^{l - 1} ) \qquad ( 15 )$$

$${X}_{E}^{l} = BatchNorm ( Dropout ( {\hat{X}}_{E}^{l} ) + {X}^{l - 1} ) \qquad ( 16 )$$

$${X}_{M}^{l} = BatchNorm ( Dropout ( {\hat{X}}_{M}^{l} ) + {X}^{l - 1} ) \qquad ( 17 )$$

where X_{T}^{l} represents a final output of the global self-attention module of layer l; X_{E}^{l} represents a final output of the graph external attention module of layer l; and X_{M}^{l} represents a final output of the message passing module of layer l.

In step 260, the normalization module performs batch normalization and random dropout on the first node representation, the second node representation, the first edge representation, the third node representation, and the second edge representation, and combination is carried out using the multilayer perceptron combination module to obtain a target output of a model.

Step 260 is mainly applied to combine the outputs of three modules to obtain the output of the model.

A multilayer perceptron includes two linear layers and one activation layer, and an output of the multilayer perceptron is an input to next layer of the model:

$${X}^{l + 1} J = {MLP}^{l} ( {X}_{T}^{l} + {X}_{E}^{l} + {X}_{M}^{l} ) \qquad ( 18 )$$

$$MLP ( Y ) = {Dropout}_{2} ( {W}_{2} ( {Dropout}_{1} ( σ ( {W}_{1} Y ) ) ) ) \qquad ( 19 )$$

where MLP represents the multilayer perceptron; Dropout represents a random dropout function; [symbol] represents a learnable parameter matrix; and σ represents an activation function.

Optionally, in step 220, since the node feature does not contain the position information of the node and the model cannot perceive the position information of the node if the feature of the node is directly input to the model, the position code of the node needs to be pre-calculated according to the adjacent matrix. The following two positional encoding ways are used in the present disclosure.

1) Laplacian positional encoding: an adjacent matrix A having a size of n×n and a degree matrix D are given, and Laplacian feature vectors of all graphs in a dataset are calculated by factorization of a Laplacian matrix of a graph:

$$I - {D}^{- 1 / 2} {AD}^{- 1 / 2} = {U}^{T} Λ U \qquad ( 20 )$$

where I represents a unit matrix, and A and U correspond to a feature value and a feature vector, respectively. For the node i, k minimum nontrivial feature vectors of the node are used as the position code pᵢ^{Lap} of the node in the present disclosure.

2) Random walk positional encoding: an adjacent matrix A having a size of n×n and a degree matrix D are given. Firstly, a random walk operator RW=AD⁻¹ is calculated, and the random walk code pᵢ^{RWPE} of step k is calculated using the random walk operator:

$${p}_{i}^{RWPE} = [ {RW}_{i i} , {RW}_{ii}^{2} , … , {RW}_{ii}^{k} ] ∈ {ℝ}^{k} \qquad ( 21 )$$

where RW_{iJ}^{k} represents a probability that node i is exactly at node J after randomly walking for k steps. In the present disclosure, because of the low complexity of use of a random walk matrix, only a landing probability of the node i to itself, i.e., RWᵢᵢ, is taken into account.

In step 230, the global self-attention module inputs the node embedding X to the global self-attention module and learns the internal global view information of the graph. In the global self-attention module, an explicit graph structure is neglected, and a relationship between nodes is inferred only using a node attribute. That is, a similarity between nodes is inferred using the self-attention mechanism. The global self-attention module is composed of two layers: a self-attention layer and a feedforward neural network layer.

In step 240, the node embedding and the edge embedding are input to the message passing module, and the internal local view information of the graph, i.e., complex structure information, is learned. The message passing network used by the message passing module may be any function acting on a local neighborhood. A gated graph convolutional neural network is used in the present disclosure.

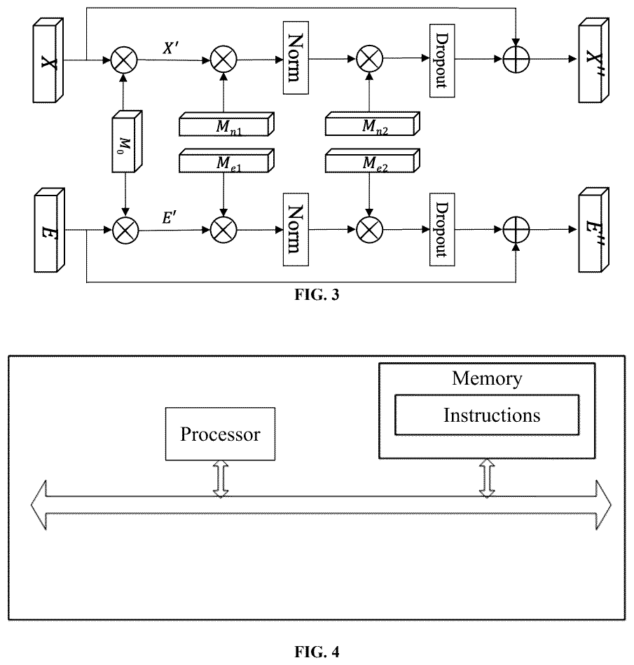

In step 250, as shown in FIG. 3, the node embedding X and the edge embedding E are input to the graph external attention module, and the external view information of the graph is learned.

Compared with an existing method, the present disclosure solves the problems of the existing method, namely neglecting information interaction between graphs, being limited to modeling of an internal relationship of a graph, and losing the capability of learning the external view information of the graph, and enables the model to learn more accurate node representations. The present disclosure has extensive utilization potentiality and is applied to a plurality of network structures and application scenarios. Since multi-view graph representation learning is applied to a plurality of fields, it is expected to promote interdisciplinary research and cooperation and combine professional knowledge and methods of different fields. In short, the present disclosure is of great significance for graph deep learning and other fields.

The present disclosure further provides a device for GEA-guided multi-view graph representation learning. As shown in FIG. 4, the device is applied to a system for GEA-guided multi-view graph representation learning. The system includes: a feature encoding module, a global self-attention module, a message passing module, a graph external attention module, a normalization module, and a multilayer perceptron combination module. The device includes:
at least one processor and a memory in communication connection with the at least one processor, where the memory stores instructions executable by the at least one processor, and the instructions, when executed by the at least one processor, enable the at least one processor to:
acquire a node feature, an edge feature, and an adjacent matrix of an input graph;
calculate, by the feature encoding module, based on the node feature, the edge feature, and the adjacent matrix, a node embedding and an edge embedding of the graph;
learn, by the global self-attention module, according to the node embedding, internal global view information of the graph, and output a first node representation of the global self-attention module;
learn, by the message passing module, according to the node embedding and the edge embedding, internal local view information of the graph, and output a second node representation and a first edge representation of the message passing module;
learn, by the graph external attention module, according to the node embedding and the edge embedding, external view information of the graph, and output a third node representation and a second edge representation of the graph external attention module; and
perform, by the normalization module, batch normalization and random dropout on the first node representation, the second node representation, the first edge representation, the third node representation, and the second edge representation, and combine using the multilayer perceptron combination module to obtain a target output of a model.

In the embodiments of the present disclosure, functional module division may be performed according to the foregoing method embodiments. For example, functional modules may be obtained through division based on corresponding functions, or two or more functions may be integrated into a processing module. The above integrated module may be implemented in a form of hardware, or may be implemented in a form of a functional module of software. It needs to be noted that the division of modules in this embodiment of the present disclosure is schematic, which is only logical function division, and there may be another division method in actual implementation.

The processor in the present disclosure may further have the functionality of the memory. The memory is configured to store computer executable instructions of the solution of the present disclosure, and the execution of the instructions is controlled by the processor. The processor is configured to execute the computer executable instructions stored in the memory so as to implement the method provided in the embodiments of the present disclosure.

The memory may be a read-only memory (ROM), another type of static storage device that can store static information and instructions, a random access memory (RAM), or another type of dynamic storage device that can store information and instructions; may be an electrically erasable programmable read-only memory (EEPROM), a compact disc read-only memory (CD-ROM), another optical disc storage, an optical disc storage (including a compact disc, a laser disc, an optical disc, a digital versatile disc, or a Blue ray disc), a disk storage medium, or another magnetic storage device; or may be any other medium that can be used to carry or store desired program code in a form of an instruction or a data structure and can be accessed by a computer, but is not limited thereto. The memory may exist independently, and is connected with the processor through a communication line. The memory may also be integrated with the processor.

Although the present disclosure has been described in combination with specific features and embodiments thereof, it is apparent that various modifications and combinations may be made without departing from the spirit and scope of the present disclosure. Correspondingly, the specification and accompanying drawings are merely exemplary descriptions of the present disclosure that are defined by the appended claims, and are deemed as covering any and all of the modifications, changes, combinations or equivalents within the scope of the present disclosure. Apparently, those skilled in the art can make various changes and modifications to the present disclosure without departing from the spirit and scope of the present disclosure. In this way, if these modifications and variations of the present disclosure fall within the scope of the claims of the present disclosure and equivalent technologies thereof, the present disclosure is further intended to include these modifications and variations.

What is claimed is:

1. A method for graph external attention (GEA)-guided multi-view graph representation learning, the method applied to a system for GEA-guided multi-view graph representation learning, the system comprising: a feature encoding module, a global self-attention module, a message passing module, a graph external attention module, a normalization module, and a multilayer perceptron combination module; the method comprising:
acquiring a node feature, an edge feature, and an adjacent matrix of an input graph;
calculating, by the feature encoding module, based on the node feature, the edge feature, and the adjacent matrix, a node embedding and an edge embedding of the graph;
learning, by the global self-attention module, according to the node embedding, internal global view information of the graph, and outputting a first node representation of the global self-attention module;
learning, by the message passing module, according to the node embedding and the edge embedding, internal local view information of the graph, and outputting a second node representation and a first edge representation of the message passing module;
learning, by the graph external attention module, according to the node embedding and the edge embedding, external view information of the graph, and outputting a third node representation and a second edge representation of the graph external attention module; and
performing, by the normalization module, batch normalization and random dropout on the first node representation, the second node representation, the first edge representation, the third node representation, and the second edge representation, and combining using the multilayer perceptron combination module to obtain a target output of a model.

2. The method for GEA-guided multi-view graph representation learning according to claim 1, wherein the calculating, by the feature encoding module, based on the node feature, the edge feature, and the adjacent matrix, a node embedding and an edge embedding of the graph comprises:
pre-calculating a position code P of a node according to the adjacent matrix, concatenating the position code P with an initial node X⁰ feature by Laplacian positional encoding or random walk positional encoding, and controlling a dimension of a feature using a linear encoder to obtain the node embedding X:
X=NodeLinearEncoder[Concat(X⁰,P)]
wherein NodeLinearEncoder represents a node feature encoder, and Concat represents a concatenating operation; and
inputting the initial edge feature E⁰ to the linear encoder to control a dimension of the edge feature to obtain an edge embedding matrix E:
E=EdgeLinearEncoder(E⁰)
wherein EdgeLinearEncoder represents an edge feature encoder.

3. The method for GEA-guided multi-view graph representation learning according to claim 1, wherein the learning, by the global self-attention module, according to the node embedding, internal global view information of the graph, and outputting a first node representation of the global self-attention module comprise:
inputting the node embedding X to the global self-attention module, and obtaining matrices of a query Q, a key K, and a value V by linear projection, wherein Q=XW_{Q}, K=XW_{K}, and V=XW_{V};
substituting the matrices of Q, the key K, and the value V into the following formula:
$${X}^{′} = SelfAttn ( X ) := AV ∈ {ℝ}^{n \times {d}_{out}}$$
$$A = ( \frac{{QK}^{T}}{\sqrt{{d}_{o u t}}} )$$
for calculating a self-attention;
wherein A represents an attention matrix; n represents a number of nodes; dₒᵤₜ refers to a feature dimension of Q; W_{Q}, W_{K}, and W_{V} are learnable parameter matrices; and Norm represents normalization, which utilizes a softmax function;
calculating and concatenating a plurality of self-attentions to obtain a multi-head self-attention; and passing an output X′ of the multi-head self-attention through a residual connection and a feedforward neural network to obtain a final output X′″ of the global self-attention module:
$${X}^{″} = {X}^{′} + SelfAttn ( {X}^{′} )$$
$${X}^{′′′} = FFN ( {X}^{″} ) := ReLU ( {X}^{″} {W}_{1} ) {W}_{2}$$
wherein FFN represents the feedforward neural network, and ReLU represents an activation function.

4. The method for GEA-guided multi-view graph representation learning according to claim 1, wherein the learning, by the message passing module, according to the node embedding and the edge embedding, internal local view information of the graph, and outputting a second node representation and a first edge representation of the message passing module comprise:
giving a node v, wherein a process of message passing for updating a feature is as follows:
$${m}_{v}^{( t + 1 )} = {\sum }_{u ∈ N ( v )} \frac{1}{\vert N ( v ) \vert} {h}_{u}^{( t )}$$
$${h}_{v}^{( t + 1 )} = Combine ( {h}_{v}^{( t )} , {m}_{v}^{( t + 1 )} )$$
wherein t represents a number of combination steps; hᵥ⁽⁰⁾ represents an initial embedding of the node v;
$${m}_{v}^{( t + 1 )}$$
represents a message passing process, which is a combination message of the node v at step t+1; N(v) represents a neighbor node set of the node v;
$${h}_{v}^{( t + 1 )}$$
represents a node representation of the node v after updating; and Combine represents a combination function.

5. The method for GEA-guided multi-view graph representation learning according to claim 1, wherein the learning, by the graph external attention module, according to the node embedding and the edge embedding, external view information of the graph, and outputting a third node representation and a second edge representation of the graph external attention module comprise:
inputting a node embedding matrix X∈ [symbol] ^{n×d}, wherein n represents a number of nodes; and d represents a feature dimension of a node;
using a shared feature memory unit M₀∈ [symbol] ^{d×d} of a node and an edge to calculate a product of the node and the shared feature memory unit, and updating a node representation:
X′=XM₀
using a first external node feature memory unit Mₙ₁∈ [symbol] ^{S×d} to calculate a similarity matrix A_{node} of the first external node feature memory unit and the node:
A_{node}=Norm(X′Mₙ₁^{T})
wherein Norm represents a normalization function, and S represents a size of a memory unit;
using a second external node feature memory unit Mₙ₂∈ [symbol] ^{S×d} to update a feature from the external node feature memory unit with a similarity in A_{node}:
$${X}^{″} = {A}_{node} {M}_{n 2} ∈ {ℝ}^{n \times d}$$
wherein X″ represents a node representation output by the graph external attention module;
inputting an edge embedding matrix E∈ [symbol] ^{e×d}, wherein e represents a number of edges; and d represents a feature dimension of an edge; using the shared feature memory unit M₀∈ [symbol] ^{d×d} to calculate a product of the edge and the shared feature memory unit, and updating an edge representation:
E′=EM₀
using a first external edge feature memory unit Mₑ₁∈ [symbol] ^{S×d} to calculate a similarity matrix of the first external edge feature memory unit and the edge:
A_{edge}=Norm(E′Mₑ₁^{T})
using a second external edge feature memory unit Mₑ₂∈ [symbol] ^{S×d} to update an input feature of the external edge feature memory unit with a similarity in A_{edge}:
$${E}^{″} = {A}_{edge} {M}_{e 2} ∈ {ℝ}^{e \times d}$$
wherein E″ represents edge representation output by the graph external attention module.

6. The method for GEA-guided multi-view graph representation learning according to claim 1, wherein the performing, by the normalization module, batch normalization and random dropout on the first node representation, the second node representation, the first edge representation, the third node representation, and the second edge representation comprises:
denoting the first node representation, the second node representation, and the third node representation as \hat{X}_{T}^{l}, \hat{X}_{M}^{l}, and \hat{X}_{E}^{l}, respectively, wherein 0<l<L, l represents a current number of layers; L represents a total number of layers; T, M, and E represent the global self-attention module, the message passing module, and the graph external attention module, respectively; and three outputs are separately passed through a Dropout function to prevent model overfitting; and
performing normalization processing using a batch normalization method BatchNorm

7. The method for GEA-guided multi-view graph representation learning according to claim 1, wherein the combining using the multilayer perceptron combination module to obtain a target output of a model comprises:
a multilayer perceptron comprising two linear layers and one activation layer, and an output of the multilayer perceptron being an input to next layer of the model:
$${X}^{l + 1} = ML {P}^{l} ( {X}_{T}^{l} + {X}_{E}^{l} + {X}_{M}^{l} )$$
$$MLP ( Y ) = {Dropout}_{2} ( {W}_{2} ( {Dropout}_{1} ( σ ( {W}_{1} Y ) ) ) )$$
wherein MLP represents the multilayer perceptron; Dropout represents a random dropout function; W represents a learnable parameter matrix; and σ represents an activation function.

8. The method for GEA-guided multi-view graph representation learning according to claim 6, wherein the learning, by the graph external attention module, according to the node embedding and the edge embedding, external view information of the graph, and outputting a third node representation and a second edge representation of the graph external attention module comprise:
representing the global self-attention module, the graph external attention module, and the message passing module with formulas, respectively:
$${X}_{T}^{l} = BatchNorm ( Dropout ( {\hat{X}}_{T}^{l} ) + {X}^{l - 1} )$$
$${X}_{E}^{l} = BatchNorm ( Dropout ( {\hat{X}}_{E}^{l} ) + {X}^{l - 1} )$$
$${X}_{M}^{l} = BatchNorm ( Dropout ( {\hat{X}}_{M}^{l} ) + {X}^{l - 1} )$$
wherein X_{T}^{l} represents a final output of the global self-attention module of layer l; X_{E}^{l} represents a final output of the graph external attention module of layer l; and X_{M}^{l} represents a final output of the message passing module of layer l.

9. A device for GEA-guided multi-view graph representation learning, the device applied to a system for GEA-guided multi-view graph representation learning, the system comprising: a feature encoding module, a global self-attention module, a message passing module, a graph external attention module, a normalization module, and a multilayer perceptron combination module; the device comprising:
at least one processor and a memory in communication connection with the at least one processor, wherein the memory stores instructions executable by the at least one processor, and the instructions, when executed by the at least one processor, enable the at least one processor to:
acquire a node feature, an edge feature, and an adjacent matrix of an input graph;
calculate, by the feature encoding module, based on the node feature, the edge feature, and the adjacent matrix, a node embedding and an edge embedding of the graph;
learn, by the global self-attention module, according to the node embedding, internal global view information of the graph, and output a first node representation of the global self-attention module;
learn, by the message passing module, according to the node embedding and the edge embedding, internal local view information of the graph, and output a second node representation and a first edge representation of the message passing module;
learn, by the graph external attention module, according to the node embedding and the edge embedding, external view information of the graph, and output a third node representation and a second edge representation of the graph external attention module; and
perform, by the normalization module, batch normalization and random dropout on the first node representation, the second node representation, the first edge representation, the third node representation, and the second edge representation, and combine using the multilayer perceptron combination module to obtain a target output of a model.

10. A non-transitory computer storage medium, storing instructions which, when run, cause the method for GEA-guided multi-view graph representation learning according to claim 1 to be implemented.

11. The non-transitory computer storage medium according to claim 10, wherein the calculating, by the feature encoding module, based on the node feature, the edge feature, and the adjacent matrix, a node embedding and an edge embedding of the graph comprises:
pre-calculating a position code P of a node according to the adjacent matrix, concatenating the position code P with an initial node feature X⁰ by Laplacian positional encoding or random walk positional encoding, and controlling a dimension of a feature using a linear encoder to obtain the node embedding X:
X32 NodeLinearEncoder[Concat(X⁰, P)]
wherein NodeLinearEncoder represents a node feature encoder, and Concat represents a concatenating operation; and
inputting the initial edge feature E⁰ to the linear encoder to control a dimension of the edge feature to obtain an edge embedding matrix E:
E=EdgeLinearEncoder(E⁰)
wherein EdgeLinearEncoder represents an edge feature encoder.

12. The non-transitory computer storage medium according to claim 10, wherein the learning, by the global self-attention module, according to the node embedding, internal global view information of the graph, and outputting a first node representation of the global self-attention module comprise:
inputting the node embedding X to the global self-attention module, and obtaining matrices of a query Q, a key K, and a value V by linear projection, wherein Q=XW_{Q}, K=XW_{K}, and V=XW_{V};
substituting the matrices of Q, the key K, and the value V into the following formula:
$${X}^{′} = SelfAttn ( X ) : AV ∈ {ℝ}^{n \times {d}_{out}}$$
$$A = Norm ( \frac{{QK}^{T}}{\sqrt{{d}_{o u t}}} )$$
for calculating a self-attention;
wherein A represents an attention matrix; n represents a number of nodes; dₒᵤₜ refers to a feature dimension of Q; W_{Q}, W_{K}, and W_{V} are learnable parameter matrices; and Norm represents normalization, which utilizes a softmax function;
calculating and concatenating a plurality of self-attentions to obtain a multi-head self-attention; and passing an output X′ of the multi-head self-attention through a residual connection and a feedforward neural network to obtain a final output X′″ of the global self-attention module:
$${X}^{″} = {X}^{′} + SelfAttn ( {X}^{′} )$$
$${X}^{′′′} = FFN ( {X}^{′′} ) := ReLU ( {X}^{″} {W}_{1} ) {W}_{2}$$
wherein FFN represents the feedforward neural network, and ReLU represents an activation function.

13. The non-transitory computer storage medium according to claim 10, wherein the learning, by the message passing module, according to the node embedding and the edge embedding, internal local view information of the graph, and outputting a second node representation and a first edge representation of the message passing module comprise:
giving a node v, wherein a process of message passing for updating a feature is as follows:
$${m}_{v}^{( t + 1 )} = {\sum }_{u ∈ N ( v )} \frac{1}{\vert N ( ν ) \vert} {h}_{u}^{( t )}$$
$${h}_{v}^{( t + 1 )} = Combine ( {h}_{v}^{( t )} , {m}_{v}^{( t + 1 )} )$$
wherein t represents a number of combination steps; hᵥ⁽⁰⁾ represents an initial embedding of the node v; mᵥ^{(t+1)} represents a message passing process, which is a combination message of the node v at step t+1; N(v) represents a neighbor node set of the node v; hᵥ^{(t+1)} represents a node representation of the node v after updating; and Combine represents a combination function.

14. The non-transitory computer storage medium according to claim 10, wherein the learning, by the graph external attention module, according to the node embedding and the edge embedding, external view information of the graph, and outputting a third node representation and a second edge representation of the graph external attention module comprise:
inputting a node embedding matrix X∈ [symbol] ^{n×d}, wherein n represents a number of nodes; and d represents a feature dimension of a node;
using a shared feature memory unit M₀∈ [symbol] ^{d×d} of a node and an edge to calculate a product of the node and the shared feature memory unit, and updating a node representation:
X′=XM₀
using a first external node feature memory unit Mₙ₁∈ [symbol] ^{S×d} to calculate a similarity matrix A_{node} of the first external node feature memory unit and the node:
A_{node}=Norm(X′Mₙ₁^{t})
wherein Norm represents a normalization function, and S represents a size of a memory unit;
using a second external node feature memory unit Mₙ₂∈ [symbol] ^{S×d} to update a feature from the external node feature memory unit with a similarity in A_{node}:
$${X}^{′′} = {A}_{node} {M}_{n 2} ∈ {ℝ}^{n \times d}$$
wherein X″ represents a node representation output by the graph external attention module;
inputting an edge embedding matrix E∈ [symbol] ^{e×d}, wherein e represents a number of edges; and d represents a feature dimension of an edge; using the shared feature memory unit M₀∈ [symbol] ^{d×d} to calculate a product of the edge and the shared feature memory unit, and updating an edge representation:
E′=EM₀
using a first external edge feature memory unit Mₑ₁∈ [symbol] ^{S×d} to calculate a similarity matrix of the first external edge feature memory unit and the edge:
A_{edge}=Norm(E′Mₑ₁^{T})
using a second external edge feature memory unit Mₑ₂∈ [symbol] ^{S×d} to update an input feature of the external edge feature memory unit with a similarity in A_{edge}:
$${E}^{″} = {A}_{edge} {M}_{e 2} ∈ {ℝ}^{e \times d}$$
wherein E″ represents edge representation output by the graph external attention module.

15. The non-transitory computer storage medium according to claim 10, wherein the performing, by the normalization module, batch normalization and random dropout on the first node representation, the second node representation, the first edge representation, the third node representation, and the second edge representation comprises:
denoting the first node representation, the second node representation, and the third node representation as \hat{X}_{T}^{l}, \hat{X}_{M}^{l}, and \hat{X}_{E}^{l}, respectively, wherein 0<l >L, l represents a current number of layers; L represents a total number of layers; T, M, and E represent the global self-attention module, the message passing module, and the graph external attention module, respectively; and three outputs are separately passed through a Dropout function to prevent model overfitting; and
performing normalization processing using a batch normalization method BatchNorm.

16. The non-transitory computer storage medium according to claim 10, wherein the combining using the multilayer perceptron combination module to obtain a target output of a model comprises:
a multilayer perceptron comprising two linear layers and one activation layer, and an output of the multilayer perceptron being an input to next layer of the model:
$${X}^{l + 1} = ML {P}^{l} ( {X}_{T}^{l} + {X}_{E}^{l} + {X}_{M}^{l} )$$
$$MLP ( Y ) = {Dropout}_{2} ( {W}_{2} ( {Dropout}_{1} ( \_ ( {W}_{1} Y ) ) ) )$$
wherein MLP represents the multilayer perceptron; Dropout represents a random dropout function; W represents a learnable parameter matrix; and _ represents an activation function.

17. The non-transitory computer storage medium according to claim 15, wherein the learning, by the graph external attention module, according to the node embedding and the edge embedding, external view information of the graph, and outputting a third node representation and a second edge representation of the graph external attention module comprise:
representing the global self-attention module, the graph external attention module, and the message passing module with formulas, respectively:
$${X}_{T}^{l} = BatchNorm ( Dropout ( {\hat{X}}_{T}^{l} ) + {X}^{l - 1} )$$
$${X}_{E}^{l} = BatchNorm ( Dropout ( {\hat{X}}_{E}^{l} ) + {X}^{l - 1} )$$
$${X}_{M}^{l} = BatchNorm ( Dropout ( {\hat{X}}_{M}^{l} ) + {X}^{l - 1} )$$
wherein X_{T}^{l} represents a final output of the global self-attention module of layer l; X_{E}^{l} represents a final output of the graph external attention module of layer l; and X_{M}^{l} represents a final output of the message passing module of layer l.
